(19) United States
(12) Patent Application Publication
(10) Pub. No.: US 2011/0017909 A1
(43) Pub. Date: Jan. 27, 2011

(54) ELECTRON IMAGING APPARATUS WITH IMAGE PROCESSING

(75) Inventor: Raymond Browning, Shoreham, NY (US)

Correspondence Address: Raymond Browning, 14 John Street, Shoreham, NY, 11786, US

(73) Assignee: Raymond Browning, Shoreham, NY (US)

(21) Appl. No.: 12/506,304

(22) Filed: Jul. 21, 2009

(51) Int. Cl. G01N 23/22; H01J 1/50

(52) U.S. Cl. 250/306; 250/396 ML

(57) ABSTRACT

A photoelectron microscope incorporating a magnetic projection lens and an image processing means to improve the spatial resolution by deconvolution of the point spread function.

An image processing method to improve the spatial resolution in magnetic projection electron lenses by deconvolution of the point spread function.

### TECHNICAL FIELD

The present invention relates generally to image processing, and more particularly to image processing in electron microscopes, and more particularly to image processing in photoelectron microscope, and more particularly to image processing in a photoelectron microscope with a magnetic projection lens, and more particularly to image processing of images formed using a magnetic projection lens having a cyclotron orbit radii filter, and more particularly to the sharpening of images using deconvolution.

### BACKGROUND INFORMATION AND DISCUSSION OF RELATED ART

Photoelectron microscopes are used for understanding the surface state of material systems. A photoelectron microscope uses photons to excite the emission of electrons from the surface of a material into a vacuum where spatial variations in the electron flux is used to image the surface. The information that can be extracted from an image includes variations in the chemistry, the crystal structure, the position of the Fermi level, and the surface potential. The kinetic energy of the emitted electron, Ekinetic is related to the energy of the photon, Ephoton, by the relationship:

Ebinding=Ephoton−Ekinetic−Φ (1)

Where Ebinding is the binding energy of the electron in the material and Φ is the work function. If the photon has sufficient energy it can cause electron emission into the vacuum from either a localized atomic level, a valency band, or a conduction level state in the material. The resultant kinetic energy of the electron can provide detailed information about the atomic species and the chemical state of the material surface. When X-ray energies are used for excitation of core level electrons the techniques is known as X-ray photoelectron spectroscopy. Because of the chemical species and chemical state specificity the technique is also known as electron spectroscopy for chemical analysis or ESCA. The electrons leave the surface with a range of energies depending on their individual history and losses in the surface of the solid. The energy of the photoelectrons leaving the sample is determined by using an electron energy analyzer, usually a high resolution concentric hemispherical analyzer (CHA). Sweeping the analyzer with energy gives a spectrum with a series of photoelectron peaks. Typically, the energy of the photoelectrons is below 1.5 keV. Because the range of electrons with energies below 1.5 keV in a material is very small, the spectrum represents the chemistry of the top few atomic layers of a material.

In a photoelectron microscope the image contrast is due to differences in spatial emission of electrons from different areas of the material. These differences are due to differences in elemental species, and their chemical states across the surface. The contrast is present as both total intensity of the emitted electrons, and as structure in the electron energy distribution. The chemical differences can be imaged by either changing the photon energy to excite a particular core level, or by analyzing the kinetic energy of the emitted electrons, and imaging only those electrons in a range of interest.

An immersion lens can be used to collect as much of the available emitted photoelectrons as is possible to reduce the time required to collect images. Beamson et. al., Nature, vol. 290, p. 556, 1981 and Turner, U.S. Pat. No. 4,486,659, teach that an axially symmetric divergent magnetic field can generate an enlarged image of a photo-emissive surface while preserving the original energy distribution. They use a current carrying solenoid to create the magnetic field. The solenoid is termed an immersion lens because the sample is immersed in the magnetic field. The solenoid is also termed a projection lens because the electrons are projected as a real image along the divergent magnetic field lines. Beamson et. al. further teach that an energy resolved image can be made by inserting a retarding field electron energy analyzer into the diverging magnetic field. Hirose, U.S. Pat. No. 5,045,696, teaches that by reducing the energy of the collected photoelectrons to those emitted with energies below 1 eV the spatial resolution can be improved in a photoelectron microscope using a projection lens. Hirose used a pulsed X-ray source and a pulsed electronic gating method to only image slower electrons but this necessarily means the high energy electrons that have chemical specificity cannot be imaged.

Beamson et. al. teach that the spatial resolution is determined by the helical cyclotron orbit radius of electrons with the maximum off axis energy. The helical trajectories have a maximum radius, Rmax, that is dependent on the energy of the electrons, E, and the magnetic field B in the following relationship:

$$R max = \frac{{( 2 mE )}^{1 / 2}}{eB} \qquad ( 2 )$$

Where m is the mass of the electron and e is the charge of the electron. Beamson et. al. predict that the ultimate effective lateral resolution, the diameter of a ‘circle of confusion’, would be Rmax/10. Beamson et. al. justify this estimate by indicating that the probability of the electrons being at a distance from the originating field line when crossing the image plane is strongly peaked in the center. Beamson et. al. make this prediction with no quantitative mathematical justification. Pianetta et al., Review Scientific Instruments, vol 60 (7), p. 1686, 1989, suggested that the figure of Rmax/10 was too low but gave no definite estimate. Kruit and Read, J. Phys E: Sci. Instrum., vol 16, 1983, calculate the spatial resolution across an edge. They find that the spatial resolution is in the region of 2Rmax. Kruit and Read point out that this measure of the spatial resolution, the ‘circle of confusion’, is effectively where half the electrons are inside a diameter 2Rmax of at the image plane. In this disclosure, we will term Kruit and Read's measure of spatial resolution being where half the electrons are within a diameter at the image plane as the 50% rule. King, Ph.D Thesis, ‘Photoelectron Microscopy’ Stanford University, Palo Alto, Calif., Chapter 2.2, p. 30, August, 1992 gives a similar figure to Kruit and Read. Clearly, from a reading of the prior art there is considerable disagreement, a factor ×20, in making an estimate of the spatial resolution for the Beamson et. al. and Turner photoelectron microscope. However, experimental results support the higher estimate of Kruit and Read. Kim et al., Rev. Sci. Instrum., vol 66, p. 3159, 1995, in commenting on the measured spatial resolution of their instrument implicitly assume the theoretical resolution is based on a figure corresponding to 2Rmax.

Browning, U.S. patent application Ser. No. 11/623,280 ‘Photoelectron Microscope’ 2007, teaches that the spatial resolution of the Beamson et. al. and Turner microscope can be improved by the addition of a cyclotron orbit radius filter (CORF) to the projection lens. When a CORF is used the spatial resolution of the microscope is much improved as the imaged photoelectrons are now constrained in the maximum cyclotron radius size. Browning teaches that with a CORF that the edge response is similar to that suggested by Kruit and Read 1983, although Browning defines the spatial resolution slightly differently and gives an estimate of Rmax.

It can be taken that the prior art consensus is that the spatial resolution of the class of photoelectron microscope having a magnetic immersion projection lens is in the region of 1-2 Rmax. No prior art discuss the concept that the spatial resolution depends not just on the geometry of the optics, but also on the image formation properties that can be used with advantage with image processing. No prior art discusses the image properties of magnetic projection microscopes in terms of how the unusual point spread function associated with this class of microscope can be used in image deconvolution to improve spatial resolution.

The spatial resolution of the Browning photoelectron microscope depends on the magnetic field at the sample and the diameter of the apertures in the CORF. With the strongest continuous magnetic fields available, 10-20T (Tesla), and with a 150 nm CORF aperture radius the spatial resolution is in the 30-10 nm region for XPS imaging. However, much of the phenomena associated with materials science and electronics is at a much smaller scale in the 1-5 nm range and below.

What is desired, therefore, is a photoelectron image processing technique that can improve the spatial resolution of the collected images that is based on a detailed understanding of the point spread function of the magnetic projection lens. The information contained in the images includes chemical species, chemical state, Fermi level, and surface potential.

### SUMMARY OF THE INVENTION

It is an object of the invention to provide an image processing method to improve the spatial resolution in magnetic projection electron lenses and similar devices.

Accordingly, the invention is characterized by a magnetic projection lens and a calculating means to improve the spatial resolution of images, whereby images collected from said magnetic projection lens can be presented with a higher spatial resolution.

The invention is further characterized by the calculating means to improve spatial resolution of images comprising: a first storage means containing a representation of the point spread function of a magnetic projection lens, a second storage means containing the image data, and a processing means, whereby said point spread function is deconvolved from said image data.

The present invention satisfies the need for an electron optical component that can be incorporated in a photoelectron microscope that is suitable for imaging surfaces with high spatial and energy resolution.

These and other aspects and benefits of the invention will become more apparent upon analysis of the drawings, specification and claims.

### BRIEF DESCRIPTION OF THE SEVERAL VIEWS OF THE DRAWINGS

The invention will be better understood and the objects and advantages of the present invention will become apparent when consideration is given to the following detailed description thereof. Such description makes reference to the annexed drawings wherein:

FIG. 1 illustrates the action of a magnetic projection lens;

FIG. 2 illustrates the action of a magnetic projection lens with a CORF;

FIG. 3 illustrates the effects of angular distribution on the trajectories of electrons leaving a sample surface in a magnetic field;

FIG. 4 illustrates how electron trajectories in a magnetic projection lens combine to limit image resolution;

FIG. 5 is the geometrical figure for calculating the probability of electron position with distance;

FIG. 6 shows the calculated probability distributions of emitted electron trajectories;

FIG. 7 shows the point spread function, or density distribution for various electron optics;

FIG. 8 shows the fast Fourier transforms for the density distributions shown in FIG. 7;

FIG. 9 is a block diagram of the imaging apparatus according to a first embodiment of this invention.

FIG. 10 is a block diagram of the imaging apparatus according to a second embodiment of this invention.

FIG. 11 is a block diagram of the imaging apparatus according to a third embodiment of this invention.

### DETAILED DESCRIPTION OF THE INVENTION

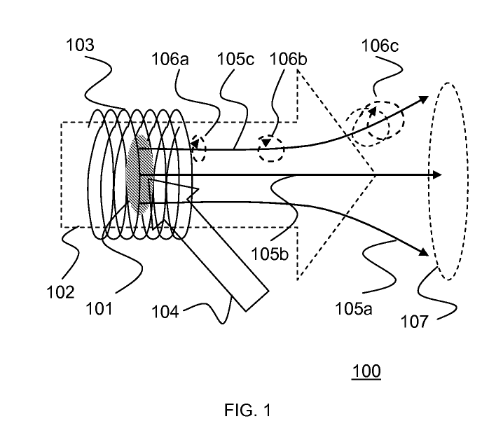

Referring to FIG. 1 through 9, wherein like reference numerals refer to like components in the various views, there is illustrated therein a new and improved image processing method.

It is an object of the invention to provide an image processing method for a projection electron lens apparatus to provide a high spatial resolution image. It is a further object of the invention to provide a high spatial resolution photoelectron microscope apparatus. It is a further object of the invention to provide a high spatial resolution photoelectron microscope apparatus comprising a magnetic projections lens, an image detection means, and an image processing means.

The invention described herein is contained in several functional elements and sub-elements individually and combined together to form the elements of a novel image processing apparatus and method.

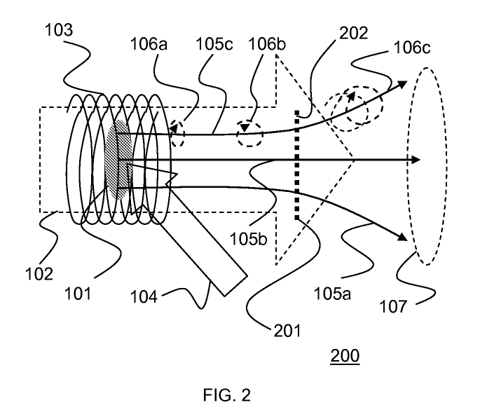

The action of a magnetic projection lens 100 is illustrated in FIG. 1. A sample 101 resides in an axial magnetic field 102 created by a current carrying solenoid 103 and illuminated by a beam of photons 104. The axial magnetic field 102 from the current carrying solenoid 103 decreases with distance along the axis of the current carrying solenoid 103 and the magnetic field lines 105a,b,c diverge. Photoelectrons emitted from the surface of the sample 101 are constrained to move along the magnetic field lines 105a,b,c in cyclotron orbits 106a,b,c which are helices along the magnetic field lines 105a,b,c. The divergence of the magnetic field lines 105a,b,c causes a magnification of the image formed by the photoelectrons of the surface of the sample 101. This magnified image can be projected onto an image plane 107. The cyclotron orbits 106a,b,c also grow larger in radius as the magnetic field decreases and the helical orbits stretch out in the direction of motion. Consequently, at the lower magnetic field at the image plane 107 the photoelectrons are moving with most of their energy in the forward direction along the field lines 105a,b,c. As shown in FIG. 2 a magnetic projection lens with a CORF 200 has a CORF grid 201 in the axial magnetic field 102. The CORF grid 201 has apertures 202 that filter the radii of the cyclotron orbits 106a,b,c.

As will be explained below the spatial resolution in the image of the magnetic projection lens 100 depends on the radii of the cyclotron orbits 106a,b,c at the surface of the sample 101. The spatial resolution in the image of the magnetic projection lens with a CORF 200 depends on the radii of the CORF grid 201 apertures 202.

The magnification, M, of the projection lens depends on the value of the axial magnetic field 102, Bsample, at the surface of the sample 101 compared to the value of the axial magnetic field 102, Bimage, at the image plane 107 with the following relationship:

$$M = {( \frac{Bsample}{Bimage} )}^{1 / 2} \qquad ( 3 )$$

The radii of the cyclotron orbits 106a,b,c change with the magnetic field in the same relationship. Thus, the relative size of the cyclotron orbits 106a,b,c and the image size stay the same and the image resolution stays the same. The cyclotron obit radius is determined by the value of the axial magnetic field and the off axis, or radial, component of the electron energy.

For the magnetic projection lens 100 the spatial resolution is limited by the cyclotron radius of the electrons emitted from the surface. The radius, r, of the electron of total energy E emitted at an angle θ to the magnetic field direction is:

$$r = \frac{{( 2 mE )}^{1 / 2} sin ( θ )}{eB} \qquad ( 4 )$$

Where B is the magnetic field strength, m is the mass of the electron, and e is the charge of the electron.

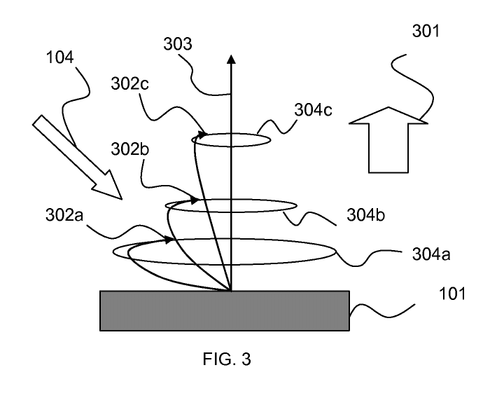

FIG. 3 illustrates how photoelectrons are emitted from a point on the surface of a sample 101 by the action of the photon beam 104. The sample 101 is sitting in a strong magnetic field with a direction 301 which is the same direction as the sample's normal 303. The coincidence of the directions is not a requirement of the operation of the projection lens. The photoelectrons are emitted at all angles typically with Lambert's cosine law, and are illustrated here by three trajectories 302a,b,c at different angles to the sample's normal 303. The trajectories 302a,b,c are helices with diameters equal to the circles 304a,b,c respectively. It can be seen that for the trajectories 302a,b emitted at larger angles to the sample's normal 303, the diameters of the circles 304b,c are larger.

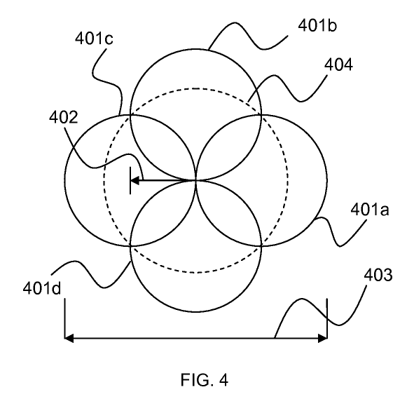

The effect of the helical electron trajectories on the image resolution is illustrated by FIG. 4. Four circles represent in plane view helical trajectories 401a,b,c,d being emitted from a point on a sample. If the helical trajectories 401a,b,c,d are projected forward to an image plane, they can intersect the image plane at any point in their cycle, and thus form a disc of confusion that defines the resolution of the point. The helical trajectories have a maximum radius 402, Rmax, that is dependent on the energy of the electrons, E, and the magnetic field B in the following relationship:

$$R max = \frac{{( 2 mE )}^{1 / 2}}{eB} \qquad ( 5 )$$

From the geometry of FIG. 4 it can be seen that the maximum spread 403 of the electrons from a single sample point is four times the maximum radius 402. Where the distribution falls to 50% of the distribution peak will define the spatial resolution as a spatial response 404.

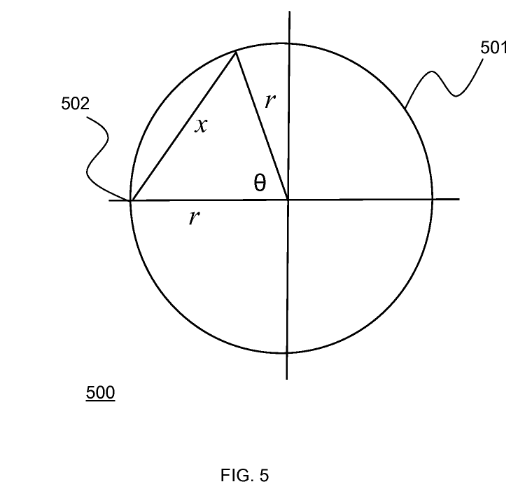

Browning adds a CORF grid 201 at a point within the projection field to filter the radii of the electron cyclotron orbits. The CORF grid 201 redefines Rmax as the radius of the apertures 202. The image forming properties of the Beamson et al. and Turner microscope and the Browning microscope are similar and depend on the same geometric construction as shown in FIG. 5.

FIG. 4 shows that the maximum spread of the electrons from a single sample point is four times the maximum radius. The probability of being at a distance x from the point of emission can be calculated using the geometry of FIG. 5. A photoelectron with cyclotron orbit 501 of radius r, is emitted from a point of emission 502. The electron can cross the image plane 107 at any point on the circumference of the cyclotron orbit 501. This point will be a distance x from the point of emission 502 where x is given by the cosine law:

$$\begin{matrix}{x}^{2} = 2 {r}^{2} - 2 {r}^{2} cos θ & ( 6 ) \\ x = r \sqrt{2 ( 1 - cos θ )} & ( 7 ) \\ θ = {cos}^{- 1} ( 1 - \frac{{x}^{2}}{2 {r}^{2}} ) & ( 8 )\end{matrix}$$

The angle θ will be randomly distributed from 0 to 2π. Therefore, the probability, P(dθ), of being between 0 and θ, will be proportional to:

$$P ( θ ) = \frac{θ}{2 π} \qquad ( 9 )$$

Substituting using Equation 6:

$$P ( x ) = \frac{1}{2 π} {cos}^{- 1} ( 1 - \frac{{x}^{2}}{2 {r}^{2}} ) \qquad ( 10 )$$

Differentiating to find the probability of an electron crossing the image plane between x and x+dx:

$$P ( d x ) = \frac{x}{2 {r}^{2} {π ( 1 - {( 1 - \frac{{x}^{2}}{2 {r}^{2}} )}^{2} )}^{1 / 2}} d x \qquad ( 11 )$$

Equation 11 is for a single radius r. For a uniform distribution of radii from 0 to r, any contribution to flux at any x will come from those electrons with radii greater than x/2 out to the maximum r. The single electron radius must be convolved with distribution of emitted radii. For a uniform distribution of radii from 0 to Rmax, the distribution for the magnetic projection lens 100 is PMPLens(dx). Note: MPLens should be understood as an acronym for magnetic projection lens 100:

$$PMPLens ( d x ) = {\int }_{x / 2}^{Rmax} \frac{x d x}{2 {r}^{2} {π ( 1 - {( 1 - \frac{{x}^{2}}{2 {r}^{2}} )}^{2} )}^{1 / 2}} d r \qquad ( 12 )$$

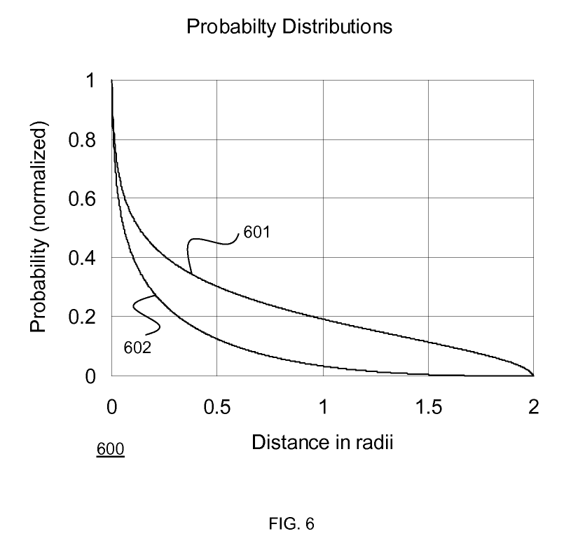

The integral can be integrated numerically. FIG. 6 is a plot of the probability distributions 600. FIG. 6 shows the magnetic projection lens probability distribution 601, PMPLens(dx), for x between 0 and 2Rmax.

The magnetic projection lens probability distribution 601 is all the electrons in a circle of diameter 4Rmax. While the distribution is peaked in the center just over half the electrons from a point source are greater than 0.5Rmax from the origin. The 50% rule of Kruit and Read gives the spatial resolution as approximately 0.5Rmax.

The CORF grid 201 defines the maximum radius of the cyclotron orbit 501 which by definition from the action of the CORF grid 201 is the physical radius of the apertures for a grid of circular apertures. The cyclotron electron orbits of radius r, with a maximum radius of the radius of the CORF grid 201 aperture Rmax, are passed with the probability:

$$P ( r ) = \frac{{( R max - r )}^{2}}{R {max}^{2}} \qquad ( 13 )$$

The integral for the magnetic projection lens with a CORF 200 gives the distribution PCORFLens(dx). Note: CORFLens should be understood as an acronym for magnetic projection lens with a CORF 200:

$$PCORFLens ( d x ) = {\int }_{x / 2}^{R max} \frac{{( R max - r )}^{2}}{R {max}^{2}} \times \frac{x d x}{2 {r}^{2} {π ( 1 - {( 1 - \frac{{x}^{2}}{2 {r}^{2}} )}^{2} )}^{1 / 2}} d r \qquad ( 14 )$$

FIG. 6 shows the magnetic projection lens with a CORF probability distribution 602, PCORFLens(dx), for x between 0 and 2Rmax.

The magnetic projection lens with a CORF probability distribution 602 is sharper than the magnetic projection lens probability distribution 601, and half the electrons are now within 0.25 Rmax.

The distribution shown in FIG. 6 is for all the electrons around in a circle of diameter 4Rmax. This is a 1 dimensional distribution but the point spread function (PSF) is usually defined as a 2 dimensional distribution, or the density function. To calculate the density function, the 1 dimensional probability distribution is divided by the area of the element dx or by 2πx. The density function is therefore dramatically peaked in the center.

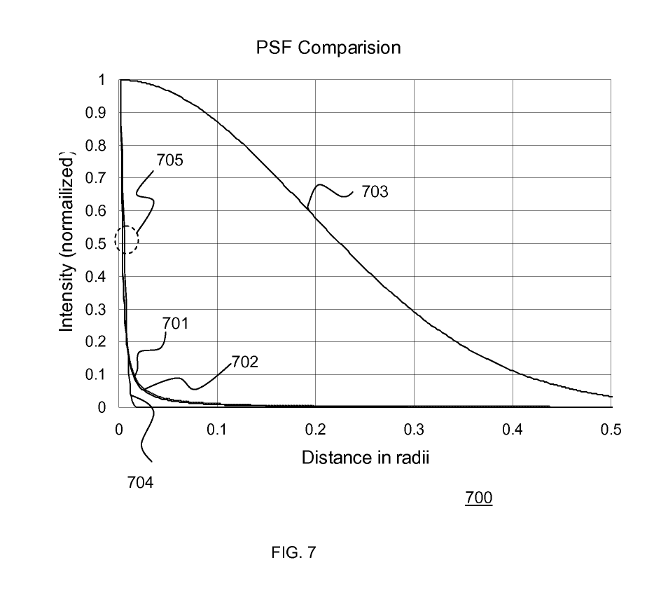

FIG. 7 shows the density functions. The magnetic projection lens density function 701 and the magnetic projection lens with a CORF density function 702 are sharply peaked at the center and very similar. They are compared with two Gaussian density functions. An electron microscope with conventional optics would typically have a Gaussian density function. The density function of the first Gaussian 703 has half of the electrons within the same radius as that for the magnetic projection lens with a CORF density function 702. This radius is at 0.25 Rmax. The second Gaussian 704 has its half height width that is similar to the half height widths of the magnetic projection lens density function 701 and the magnetic projection lens with a CORF density function 702. As can be seen, the magnetic projection lens density function 701, and the magnetic projection lens with a CORF density function 702 are very different in shape to the distributions from Gaussian optics. This has implications for the image processing of images from the magnetic projection lens 100 and the magnetic projection lens with a CORF 200.

One method to improve spatial resolution in an image collected through any electron optics is to deconvolve the point spread function of the electron optics from the collected image.

As will be understood by those skilled in the art, there are many methods used to deconvolve a known point spread function from an image. There are also many methods that use a blind deconvolution which requires very little knowledge of the imaging optics. There are also methods that use a mixture of deconvolution and smoothing to remove artifacts, and noise from the images. Depending on the point spread function, which is typically Gaussian like for electron optics, or diffraction like for light optics, and the signal to noise in the image, a varying degree of success can be obtained by using deconvolution to sharpen images. No prior art is based on an understanding of the point spread function of a magnetic projections lens 100, or the magnetic projection lens with a CORF 200.

It is a feature of this invention that the success of deconvolution of the images from a magnetic projections lens 100, or the magnetic projection lens with a CORF 200 is based on the properties of the point spread function for this class of lens.

To have a successful deconvolution method, there must be high resolution information actually present in the image, or as many practitioners of prior art have found, noise is amplified, artifacts are created, and only modest gains in resolution can be obtained. The high resolution information is equivalent to a high spatial frequency as a small spatial distance d is inversely proportional to a high spatial frequency f.

$$f ∝ \frac{1}{d} \qquad ( 15 )$$

The point spread functions of the magnetic projections lens 100, and the magnetic projection lens with a CORF 200 have very high spatial frequencies compared to the first Gaussian 703 which has the same 50% probability distribution. This can be shown by calculating the fast Fourier transform of the distributions. The fast Fourier transform is conventionally referred to as the FFT.

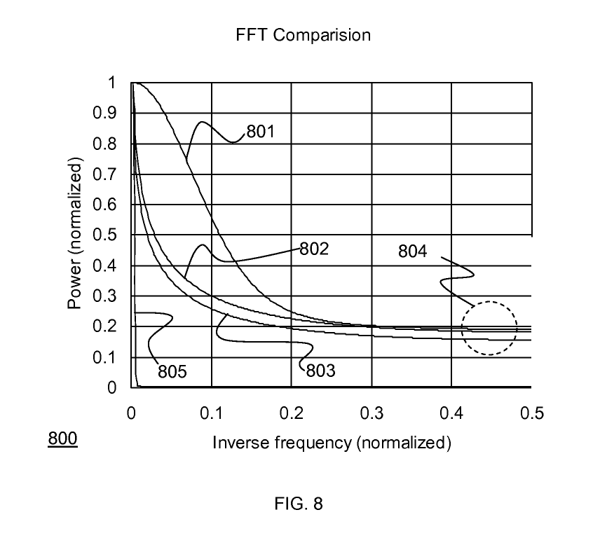

FIG. 8 shows a comparison of fast Fourier transforms 800 of the point spread function comparison 700. The higher the frequency, the higher the spatial resolution available. The amount of power in the higher spatial frequencies gives an indication of how successful any deconvolution will be for any fixed signal to noise in the image.

The FFT of a Gaussian is also a Gaussian. The width of the PSF Gaussian is inversely related to the width of the FFT Gaussian. Thus, the higher resolution second Gaussian 704 has a broad FFT Gaussian, the second FFT Gaussian 801. The wider first Gaussian 703 has a very narrow first Gaussian FFT 805.

The FFTs of the magnetic projections lens 100, and the magnetic projection lens with a CORF 200 are very similar. The magnetic projections lens FFT 803, and the magnetic projection lens with a CORF FFT 802 are very similar with power in the high frequency region 804 that is similar to the second Gaussian FFT 801. In other words, the spatial resolution available from the magnetic projections lens 100, and the magnetic projection lens with a CORF 200 is similar to the spatial resolution of the second Gaussian 704. The spatial resolution of the second Gaussian 704 is 40 times higher resolution than the first Gaussian 703. Thus, we have two unobvious facts, the first fact is that the 50% rule is not appropriate to magnetic projection lens imaging with an image processing apparatus. The second fact is that the equivalent Gaussian to the projection lens type of optics is 40 times higher in spatial resolution. No prior art has suggested this result, and thus this is a basis for a novel imaging technique, and equipment unanticipated by prior art. The results here are unobvious in that they require several steps of sophisticated mathematical calculations to derive them.

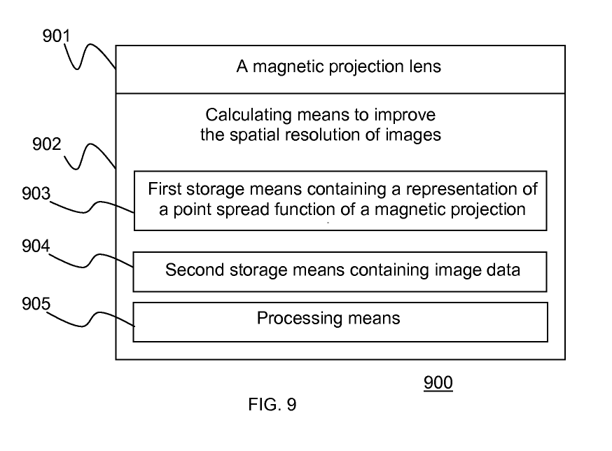

A block diagram of an imaging apparatus according to a first embodiment of this invention required to produce high spatial resolution images is shown in FIG. 9. The imaging apparatus 900, comprises: a magnetic projection lens 901; a calculating means to improve the spatial resolution of images 902; whereby images collected from said magnetic projection lens can be presented with a higher spatial resolution.

The calculating means to improve spatial resolution of images 902 comprises: a first storage means containing a representation of the point spread function of said magnetic projection lens 903; a second storage means containing image data 904; and a processing means 905, whereby said point spread function is deconvolved from said image data.

As will be appreciated by those ordinarily skilled in the art, modifications, and additions can be made to the apparatus shown in FIG. 9.

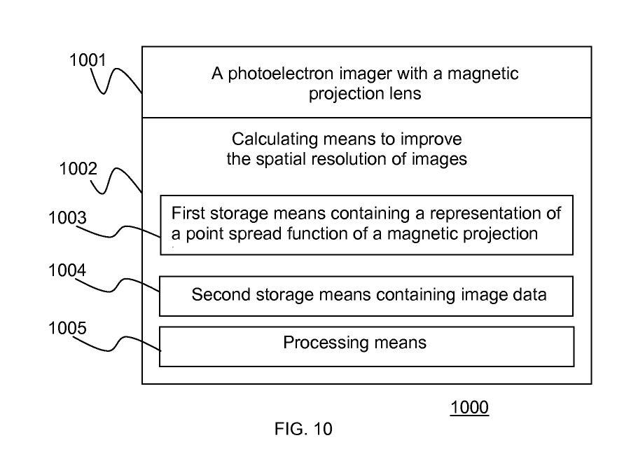

A block diagram of a photoelectron microscope according to a second embodiment of this invention required to produce high spatial resolution photoelectron images is shown in FIG. 10. The photoelectron microscope 1000, comprises: a photoelectron imager with a magnetic projection lens 1001; a calculating means to improve the spatial resolution of images 1002; whereby images collected from said photoelectron imager with a magnetic projection lens 1001 can be presented with a higher spatial resolution.

The calculating means to improve spatial resolution of images 1002 comprises: a first storage means containing a representation of the point spread function of said photoelectron imager with a magnetic projection lens 1003; a second storage means containing image data 1004; and a processing means 1005, whereby said point spread function is deconvolved from said image data.

As will be appreciated by those ordinarily skilled in the art, modifications, and additions can be made to the apparatus shown in FIG. 10.

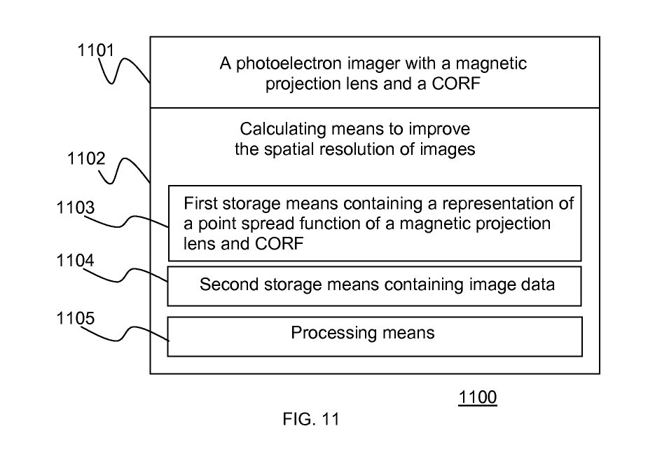

A block diagram of a photoelectron microscope according to a third embodiment of this invention required to produce high spatial resolution photoelectron images is shown in FIG. 11. The photoelectron microscope 1100, comprises: a photoelectron imager with a magnetic projection lens and CORF 1101; a calculating means to improve the spatial resolution of images 1102; whereby images collected from said photoelectron imager with a magnetic projection lens and CORF 1101 can be presented with a higher spatial resolution.

The calculating means to improve spatial resolution of images 1102 comprises: a first storage means containing a representation of the point spread function of a magnetic projection lens and CORF 1103; a second storage means containing the image data 1104; and a processing means 1105, whereby said point spread function is deconvolved from said image data.

As will be appreciated by those ordinarily skilled in the art, modifications, and additions can be made to the apparatus shown in FIG. 11.

The above disclosure is sufficient to enable one of ordinary skill in the art to practice the invention, and provide the best mode of practicing the invention presently contemplated by the inventor. While there is provided herein a full, and complete disclosure of the preferred embodiments of this invention, it is not desired to limit the invention to the exact construction, dimensional relationships, and operation shown and described. Various modifications, alternative constructions, changes and equivalents will readily occur to those skilled in the art and may be employed, as suitable, without departing from the true spirit, and scope of the invention. Such changes might involve alternative components, structural arrangements, sizes, shapes, forms, functions, operational features or the like.

I claim:

1. An imaging apparatus comprising:
(a) a magnetic projection lens;
(b) a calculating means to improve the spatial resolution of images;
whereby said images collected from said magnetic projection lens can be presented with higher spatial resolution.

2. Said calculating means of claim 1 comprising;
(a) a first storage means containing a representation of the point spread function of said magnetic projection lens;
(b) a second storage means containing image data;
(b) a processing means;
whereby said point spread function is deconvolved from said image data.

3. A photoelectron microscope comprising:
(a) a photoelectron imager with a magnetic projection lens;
(b) a calculating means to improve the spatial resolution of images;
whereby said images collected from said photoelectron imager with a magnetic projection lens can be presented with a higher spatial resolution.

4. Said calculating means of claim 3 comprising;
(a) a first storage means containing a representation of the point spread function of said photoelectron imager with a magnetic projection lens;
(b) a second storage means containing image data;
(b) a processing means;
whereby said point spread function is deconvolved from said image data.

5. A photoelectron microscope comprising:
(a) a photoelectron imager with a magnetic projection lens and CORF;
(b) a calculating means to improve the spatial resolution of images;
whereby said images collected from said photoelectron imager with a magnetic projection lens and CORF can be presented with a higher spatial resolution.

6. Said calculating means of claim 5 comprising;
(a) a first storage means containing a representation of the point spread function of said photoelectron imager with a magnetic projection lens and CORF;
(b) a second storage means containing image data;
(b) a processing means;
whereby said point spread function is deconvolved from said image data.
